(19) United States
(12) Patent Application Publication
(10) Pub. No.: US 2015/0103071 A1
(43) Pub. Date: Apr. 16, 2015

(54) METHOD AND APPARATUS FOR RENDERING OBJECT AND RECORDING MEDIUM FOR RENDERING

(71) Applicant: SAMSUNG ELECTRONICS CO., LTD., Suwon-si (KR)

(72) Inventors: Min-young SON, Hwaseong-si (KR); Kwon-taek KWON, Seoul (KR); Jeong-soo PARK, Gwacheon-si (KR); Min-kyu JEONG, Yongin-si (KR)

(73) Assignee: SAMSUNG ELECTRONICS CO., LTD., Suwon-si (KR)

(21) Appl. No.: 14/275,206

(22) Filed: May 12, 2014

(30) Foreign Application Priority Data
Oct. 10, 2013 (KR) 10-2013-0120868

(51) Int. Cl. G06T 15/00; G09G 5/02; G06K 9/46

(52) U.S. Cl. CPC G06T 15/00; G06K 9/4604; G09G 5/02
USPC 345/419

(57) ABSTRACT

Provided are graphics data rendering methods. The method includes obtaining, at a graphics data renderer, first space information of at least one object corresponding to graphics data of a first frame, determining a sampling mode of the first frame, based on the graphics data, and rendering graphics data of a second frame based on the first space information and the sampling mode of the first frame. Thus, memory space and time that are used for rendering graphics data may be reduced.

### RELATED APPLICATIONS

This application claims the benefit under 35 USC 119(a) of Korean Patent Application No. 10-2013-0120868, filed on Oct. 10, 2013, in the Korean Intellectual Property Office, the entire disclosure of which is incorporated herein by reference for all purposes.

### BACKGROUND

1. Field

The following description relates to methods and apparatuses for rendering graphics data and a recording medium for performing the same.

2. Description of Related Art

Devices for displaying three-dimensional (3D) graphics data on a screen are increasingly being used. For example, devices using a user interface (UI) application for a mobile device or an application for a simulation are expanding.

Rendering speed is one major element which needs to be taken into account when displaying graphics data on a screen. In the case of typical technology for rendering graphics data, a rendering operation is performed independently for each frame. If graphics data of a plurality of frames are to be rendered, the entirety of the graphics data included in each frame needs to be rendered. This may increase the number of operations required and the amount of required memory and time for rendering.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a rendering method, including obtaining, at a graphics data renderer, first space information of at least one object corresponding to graphics data of a first frame, determining a sampling mode of the first frame, based on the graphics data, and rendering graphics data of a second frame based on the first space information and the sampling mode of the first frame.

The rendering of the graphics data may include rendering the graphics data based on space information of at least one object corresponding to graphics data of a previous frame from among a plurality of frames and a sampling mode of the previous frame.

The determining of the sampling mode of the first frame may include determining complexity of a plurality of pixels included in the first frame based on graphics data comprising color information or depth information of the plurality of pixels, and determining a sampling mode of at least one of the plurality of pixels included in the first frame based on the determined complexity of the at least one pixel, wherein the sampling mode comprises information about a number of times a pixel is sampled and information about a type of a sampling method.

The determining of the sampling mode may include determining the sampling mode based on a sampling level that corresponds to the determined complexity, from among a plurality of sampling levels.

The rendering of the graphics data may include obtaining second space information of at least one object corresponding to graphics data of the second frame, generating a motion vector to evaluate a motion of at least one object in the first frame based on the first space information and the second space information, and determining a sampling mode of the second frame based on the generated motion vector and the sampling mode of the first frame.

The generating of the motion vector may include comparing the first space information of the first frame with the second space information of the second frame, and generating the motion vector based on the comparing, wherein space information comprises at least one of location information or depth information of the at least one object in a frame.

The determining of the sampling mode of the second frame may include detecting a pixel from the second frame that corresponds to a plurality of pixels included in the first frame based on the generated motion vector, and determining a sampling mode of the detected pixel to be same as a sampling mode of a pixel of the first frame, wherein the pixel of the first frame corresponds to the detected pixel of the second frame.

The determining of the sampling mode of the second frame may include determining a sampling mode of pixels from among a plurality of pixels of the second frame, other than the detected pixel of the second frame, based on the graphics data of the second frame.

In another general aspect, there is provided a rendering apparatus, including a space information obtainer configured to obtain first space information of at least one object corresponding to graphics data of a first frame, a sampling mode determiner configured to determine a sampling mode of the first frame based on the graphics data, and a renderer configured to render graphics data of a second frame based on the first space information and the sampling mode of the first frame.

The renderer may be further configured to renders graphics data of a current frame based on space information of at least one object corresponding to graphics data of a previous frame from among a plurality of frames and a sampling mode of the previous frame.

The sampling mode determiner may be further configured to determine complexity of a plurality of pixels included in the first frame based on graphics data comprising color information or depth information of the plurality of pixels, and determine a sampling mode of at least one of the plurality of pixels included in the first frame based on the determined complexity of the at least one pixel, wherein the sampling mode comprises information about a number of times a pixel is sampled and information about a type of a sampling method.

The sampling mode determiner may be further configured to determine the sampling mode based on a sampling level that corresponds to the determined complexity, from among a plurality of sampling levels.

The renderer may be further configured to control the space information obtainer to obtain second space information of at least one object, which is represented by graphics data of the second frame, generate a motion vector to evaluate a motion of at least one object in the first frame based on the first space information and the second space information, and determine a sampling mode of the second frame based on the generated motion vector and the sampling mode of the first frame.

The space information obtainer may be further configured to: compare the first space information of the first frame with the second space information of the second frame, and generate the motion vector based on the comparison, and wherein space information comprises at least one of location information or depth information of the at least one object in a frame.

The sampling mode determiner may be further configured to detect a pixel from the second frame that corresponds to a plurality of pixels included in the first frame based on the generated motion vector, and determine a sampling mode of the detected pixel to be same as a sampling mode of a pixel of the first frame, wherein the pixel of the first frame corresponds to the detected pixel of the second frame.

The sampling mode determination unit may determine a sampling mode of pixels from among a plurality of pixels that are included in the second frame, other than the detected pixel of the second frame, based on the graphics data of the second frame.

Other features and aspects will be apparent from the following detailed description, the drawings, and the claims.

### BRIEF DESCRIPTION OF THE DRAWINGS

FIG. 1 is a diagram illustrating an example of a graphics data rendering system.

FIG. 2 is a diagram illustrating an example of a graphics data rendering method, which is performed by a graphics data rendering apparatus.

FIG. 3 is a diagram illustrating an example of the graphics data rendering method, which is performed by the graphics data rendering apparatus.

FIG. 4 is a diagram illustrating an example of a method of determining a sampling mode based on complexity of a plurality of pixel that is included in a first frame, which is performed by the graphics data rendering apparatus.

FIG. 5 is a diagram illustrating an example of a method of determining a sampling mode of a plurality of pixels which are included in a second frame based on a motion vector, which is performed by the graphics data rendering apparatus.

FIGS. 6A through 6C are diagrams illustrating an example of a method of determining a sampling mode of a first frame, which is performed by the graphics data rendering apparatus.

FIGS. 7A through 7C are sequential diagrams illustrating an example of a method of determining a sampling mode of a second frame, which is performed by the graphics data rendering apparatus.

FIG. 8 is a diagram illustrating an example of the graphics data rendering system.

Throughout the drawings and the detailed description, unless otherwise described, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

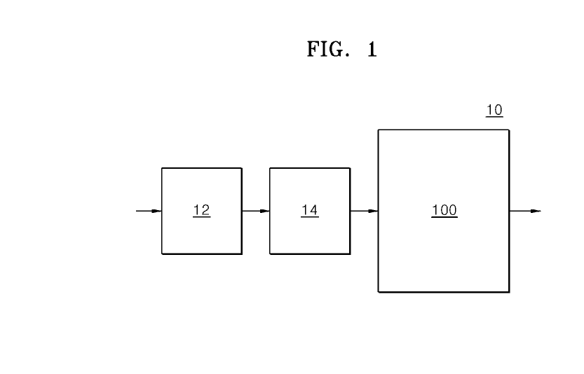

FIG. 1 is a diagram illustrating an example of a graphics data rendering system 10. Only some elements of the graphics data rendering system 10 are shown in FIG. 1. However, it may be understood by one of ordinary skill in the art that, in addition to the elements shown in FIG. 1, other general-use elements may be further included.

Referring to FIG. 1, the graphics data rendering system 10 may include a graphics application 12, a graphics processing unit (GPU) driver 14, and a graphics data rendering apparatus 100. The graphic data rendering system 10 may be a part of a system such as, for example, a computer, a wireless communication device, or a stand-alone system.

A graphics application may be an application, such as, for example, an application for operation related to a video game, graphics operations, or a video conference. The graphics application 12 may generate a high-level command to execute a graphics operation with regard to graphics data. Graphics data may include geometry information, for example, information about a vertex of a primitive in an image, or texture information. The graphics application 12 may be connected to the GPU driver 14 via an application programming interface (not illustrated in FIG. 1).

The GPU driver 14 may be a combination of software, firmware, or hardware units that are executed by a processor. The GPU driver 14 may convert a high-level command, which is received from the graphics application 12, into a low-level command.

The GPU driver 14 may show a location of data, for example, a buffer that stores data. The GPU driver 14 may transmit a low-level command and information that shows a data location to the graphics data rendering apparatus 100.

The graphics data rendering apparatus 100 may include a processing unit that performs various functions for rendering an image. The terms “processing unit,” “engine,” “core,” and “machine” may be used interchangeably throughout the application.

The graphics data rendering apparatus 100 may render graphics data that is included in a plurality of frames. Based on information that is obtained in rendering graphics data that is included in a current frame, the graphics data rendering apparatus 100 may render graphics data that is included in a next frame.

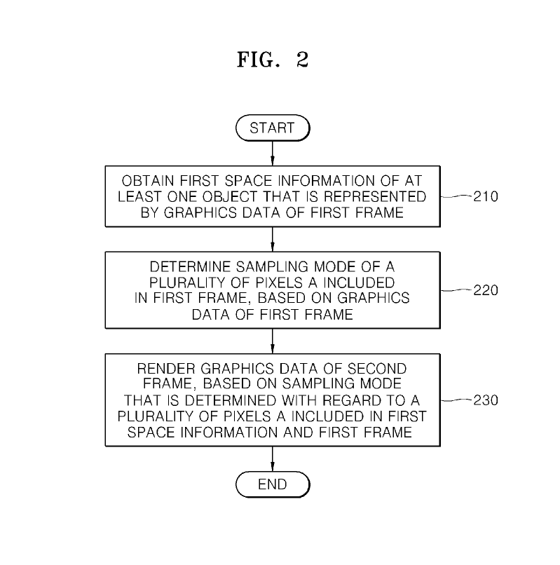

A graphics data rendering method, which is performed by the graphics rendering apparatus 100, is described in detail by referring to FIG. 2. FIG. 2 is a diagram illustrating an example of the graphics data rendering method, which is performed by the graphics data rendering apparatus 100. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently.

In operation 210, the graphics data rendering apparatus 100 may obtain first space information of at least one object, which is represented by graphics data of a first frame. An object may include a primitive, which is a basic unit of geometric data that constitutes graphics data. A primitive may include a polygon such as a triangle, a line, or a point.

The graphics data rendering apparatus 100 may identify graphics data of the first frame, based on the first space information. For example, the first space information may include location information or depth information of at least one object in the first frame, which is represented by graphics data of the first frame.

The graphics data rendering apparatus 100 may identify a degree by which graphics data is changed from the first frame to a second frame, which is a next frame of the first frame, based on the first space information. For example, if an object A is located at a point x in a first frame and is located at a point y in a second frame, then as a frame of the graphics data is changed from the first frame to the second frame, the graphics data rendering apparatus 100 may obtain information indicating that the object A has moved by a distance equal to a location difference between the point y and the point x.

In operation 220, the graphics data rendering apparatus 100 may determine a sampling mode of the first frame, based on the graphics data of the first frame. The graphics data may include color information and depth information of an object. The sampling mode may include information about the number of times a pixel is sampled, or information about a type of a sampling method.

The graphics data rendering apparatus 100 may determine complexity of a plurality of pixels that are included in the first frame, based on the graphics data of the first frame. The graphics data rendering apparatus 100 may determine complexity of a plurality of blocks that are included in the first frame, based on the graphics data of the first frame. A block may include certain number of pixels. A pixel and a block, described herein, are just units but the present disclosure is not limited thereto. Other units are considered to be well within the scope of the present disclosure. Hereinafter, for convenience of description, it is assumed that complexity of the first frame is determined in terms of units of pixels.

Complexity may be determined based on the number of pieces of attribute information of an object, for example, color information or depth information. For example, in an nth pixel from among a plurality of pixels that constitute the first frame, three objects that are included in the first frame may be present and may overlap with one other. The nth pixel may include color information about all the three objects. While only one object may be present in a 2 nth pixel. In other words, the 2 nth pixel may include color information about the one object. In this case, complexity of the nth pixel may be greater than complexity of the 2 nth pixel.

The graphics data rendering apparatus 100 may set the number of times a pixel having a greater complexity to be higher than the number of times a pixel having a lower complexity. The graphics data rendering apparatus 100 may determine a sampling level based on complexity of a pixel. A sampling level may be classified according to the number of times a pixel is sampled or a type of a sampling method.

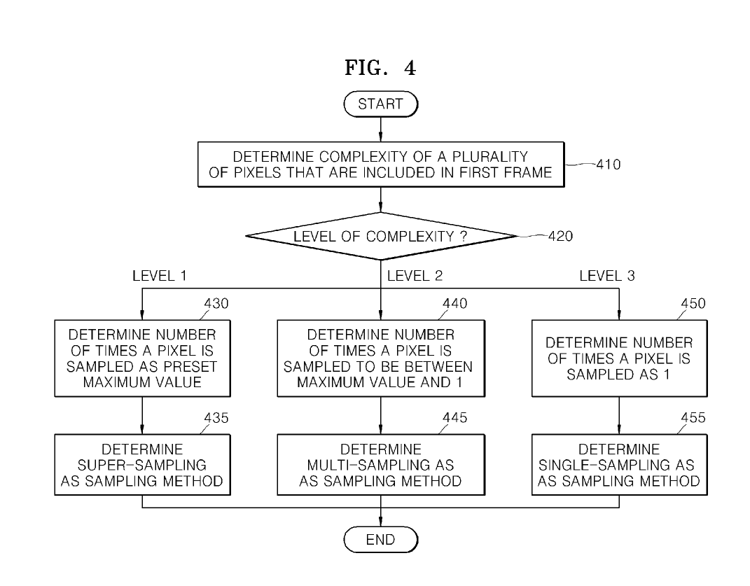

The graphics data rendering apparatus 100 may determine a type of a sampling method according to a degree of complexity of a pixel. Types of a sampling method may include a super sampling method, a multi-sampling method, and a single sampling method. A method of determining a sampling mode based on complexity of a pixel, which is performed by the graphics data rendering apparatus 100, will be described with reference to FIG. 4.

In operation 230, the graphics data rendering apparatus 100 may render graphics data of a second frame, based on the first space information and the sampling mode of the first frame.

The graphics data rendering apparatus 100 may render the graphics data of the second frame, based on information that is obtained in a process of rendering the first frame. Information that is obtained in a process of rendering the first frame may include the first space information of the first frame and a sampling mode of a plurality of pixels that are included in the first frame.

The graphics data rendering apparatus 100 may compare the first space information of the first frame to second space information of the second frame, and thus identify a degree of change in graphics data according to a change from a first frame to a second frame. In consideration of a degree of change in graphics data according to the change from the first frame to the second frame, the graphics data rendering apparatus 100 may use the sampling mode for the plurality of pixels, which is determined with regard to the first frame, for sampling a plurality of pixels that are included in the second frame.

For example, by comparing the first space information to the second space information, the graphics data rendering apparatus 100 may obtain information indicating that, as the first frame is changed to the second frame, graphics data have moved three pixels to the right and two pixels to the left. The graphics data rendering apparatus 100 may set a sampling mode for a plurality of pixels that are included in the second frame to be equal to a sampling mode which is determined with regard to the plurality of pixels included in the first frame in correspondence with a degree by which the graphics data has moved.

For example, the graphics data rendering apparatus 100 may generate a first sampling map, which includes information about a sampling mode for the plurality of pixels that are included in the first frame. The graphics data rendering apparatus 100 may move the first sampling map three pixels to the right and two pixels to the left, and thus use the moved first sampling map as a second sampling map. The graphics data rendering apparatus 100 may determine a sampling mode of some pixels of the second frame, which do not correspond to the first sampling map, based on the graphics data of the second frame.

The graphics data rendering apparatus 100 may render graphics data of a current frame, based on space information of at least one object which is represented by graphics data of a previous frame from among a plurality of frames, and a sampling mode for a plurality of pixels that are included in the previous frame. The graphics data rendering apparatus 100 may reduce time and a memory size for rendering by using a sampling mode which is determined in a process of rendering the previous frame, for a process of rendering a current frame.

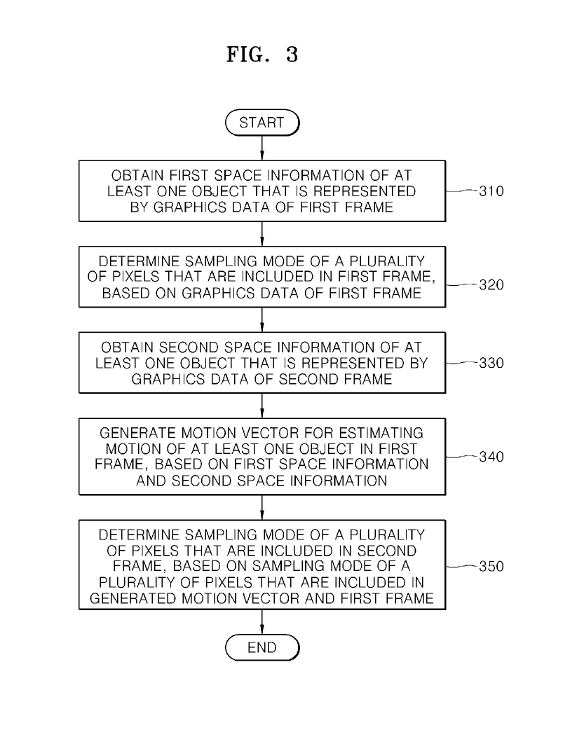

FIG. 3 is a diagram illustrating an example of a graphics data rendering method, which is performed by the graphics data rendering apparatus 100.

In operation 310, the graphics data rendering apparatus 100 may obtain first space information of at least one object, which is represented by graphics data of a first frame. The graphics data rendering apparatus 100 may identify graphics data of the first frame, based on the first space information. For example, the first space information may include location information or depth information of at least one object in the first frame that is represented by the graphics data of the first frame.

In operation 320, the graphics data rendering apparatus 100 may determine a sampling mode of the first frame, based on the graphics data of the first frame. The graphics data may include color information and depth information of an object. Additionally, the sampling mode may include information about the number of times a pixel is sampled, or information about a type of a sampling method.

The graphics data rendering apparatus 100 may determine complexity of a plurality of pixels that are included in the first frame, based on the graphics data of the first frame. Complexity may be determined based on the number of pieces of attribute information of an object, which is included in one pixel.

In operation 330, the graphics data rendering apparatus 100 may obtain second space information of at least one object, which is represented by graphics data of a second frame. The graphics data rendering apparatus 100 may identify graphics data of the second frame, based on the second space information. For example, the second space information may include location information or depth information of at least one object in the second frame, which is represented by the graphics data of the second frame.

In operation 340, the graphics data rendering apparatus 100 may generate a motion vector for estimating a motion of at least one object in the first frame, based on the first space information and the second space information.

The graphics data rendering apparatus 100 may compare the first space information of the first frame to the second space information of the second frame to estimate a motion of at least one object in the first frame.

The first space information may be depth information of at least one object in the first frame. For example, the graphics data rendering apparatus 100 may generate a depth information map for a plurality of pixels that are included in the first frame, based on depth information of at least one object in the first frame. Additionally, the graphics data rendering apparatus 100 may generate a depth information map for a plurality of pixels that are included in the second frame, based on depth information of at least one object in the second frame.

The graphics data rendering apparatus 100 may compare the depth information map of the first frame to the depth information map of the second frame. The graphics data rendering apparatus 100 may generate a motion vector, based on displacement information that is obtained by moving the depth information map of the first frame to correspond to the depth information map of the second frame.

In operation 350, the graphics data rendering apparatus 100 may determine a sampling mode of the second frame, based on the generated motion vector and the sampling mode of the first frame.

The graphics data rendering apparatus 100 may identify a relation between the graphics data of the first frame and the graphics data of the second frame, based on the generated motion vector. The relation between graphics data may be a degree by which graphics data has changed from a first frame to a second frame. For example, a change in a location of objects from a first frame to a second frame may be included in a change in graphics data.

The graphics data rendering apparatus 100 may employ a sampling mode that is determined with regard to the plurality of pixels that is included in the first frame, to determine a sampling mode of the plurality of pixels that is included the second frame, based on the relation between the graphics data of the first frame and the graphics data of the second frame. As a result of the comparing the graphics data of the first frame to the graphics data of the second frame, if the graphics data is moved from a first frame to a second frame, the graphics data rendering apparatus 100 may map a sampling mode which is determined with regard to the plurality of pixels that are included in the first frame on a sampling mode of the plurality of pixels included in the second frame.

The graphics data rendering apparatus 100 may adjust the sampling mode of the plurality of pixel that is included in the second frame by moving the sampling mode of the plurality of pixel that is included in the first frame in correspondence with a motion vector. The graphics data rendering apparatus 100 may determine a sampling mode of a second pixel of the second frame, which corresponds to a first pixel of the first frame, to be the same as a sampling mode of the first pixel. With regard to a pixel of the second frame that does not correspond to a pixel of the first frame the graphics data rendering apparatus 100 may determine a sampling mode based on the graphics data of the second frame.

FIG. 4 is a diagram illustrating an example of a method of determining a sampling mode based on complexity of a plurality of pixel that is included in a first frame, which is performed by the graphics data rendering apparatus 100.

In operation 410, the graphics data rendering apparatus 100 may determine complexity of a plurality of pixels that are included in the first frame, based on graphics data that includes color information or depth information of a plurality of pixels, which are included in the first frame.

The graphics data rendering apparatus 100 may set the number of times a pixel having a greater complexity is sampled, to be higher than the number of times a pixel having a lower complexity is sampled. According to another example, the graphics data rendering apparatus 100 may set the number of times a pixel is sampled according to a level of complexity of the pixel. Additionally, the graphics data rendering apparatus 100 may determine a type of a sampling method according to a degree of complexity of a pixel.

In operation 420, the graphics data rendering apparatus 100 may determine a sampling mode of each pixel based on a preset sampling level, according to the level of complexity that is determined with regard to each of the plurality of pixels.

Referring to FIG. 4, a sampling level may be classified into three levels. For example, if complexity of a pixel is equal to or higher than 10, a sampling mode to be applied to a pixel may be determined to be of level 1. If complexity of a pixel is equal to or higher than 5 and less than 10, a sampling mode of a pixel may be determined to be of level 2. If complexity of a pixel is less than 5, a sampling mode of a pixel may be determined to be of level 3. A value of complexity of a pixel is based on graphics data of a frame. A specific number of a value of complexity may vary according to a user setting.

In operation 430, the graphics data rendering apparatus 100 may determine the number of times a pixel is sampled based on a sampling level of 1. The graphics data rendering apparatus 100 may determine a pixel, having a sampling level of 1, to be sampled for x times, which is a preset maximum number of times of executing sampling.

In operation 435, based on the sampling level of 1, the graphics data rendering apparatus 100 may determine the type of sampling method to be a super sampling method. However, this is a non-exhaustive example, and the type of a sampling method may be determined variously according to a selection made by a user.

In operation 440, the graphics data rendering apparatus 100 may determine the number of times a pixel is sampled based on a sampling level of 2. The graphics data rendering apparatus 100 may determine the number of times a pixel with a sampling level of 2 is sampled as a value between x and 1. “x” being the preset maximum value and “1” being the preset minimum value. A number of times that a pixel is sampled may vary according to a setting made by a user. If a user classifies the sampling level of 2 into sub-levels, the number of times a pixel is sampled may be determined based on a sub-level that corresponds to a complexity of a pixel. According to another non-exhaustive example, with regard to all pixels with a sampling level of 2, the number of times a pixel is sampled may be determined as y, which is a value between x and 1.

In operation 445, based on the sampling level of 2, the graphics data rendering apparatus 100 may determine the type of sampling method to be a multi-sampling method. However, this is a non-exhaustive example, and the type of a sampling method may be determined variously according to a selection made by a user.

In operation 450, the graphics data rendering apparatus 100 may determine a count of sampling for a certain pixel, based on a sampling level of 3. The graphics data rendering apparatus 100 may determine a pixel, having a sampling level of 3, to be sampled for one time, which is a preset minimum number of times of executing sampling.

In operation 445, based on the sampling level of 3, the graphics data rendering apparatus 100 may determine the type of sampling method to be a single-sampling method. However, this is a non-exhaustive example, and the type of a sampling method may be determined variously according to a selection made by a user.

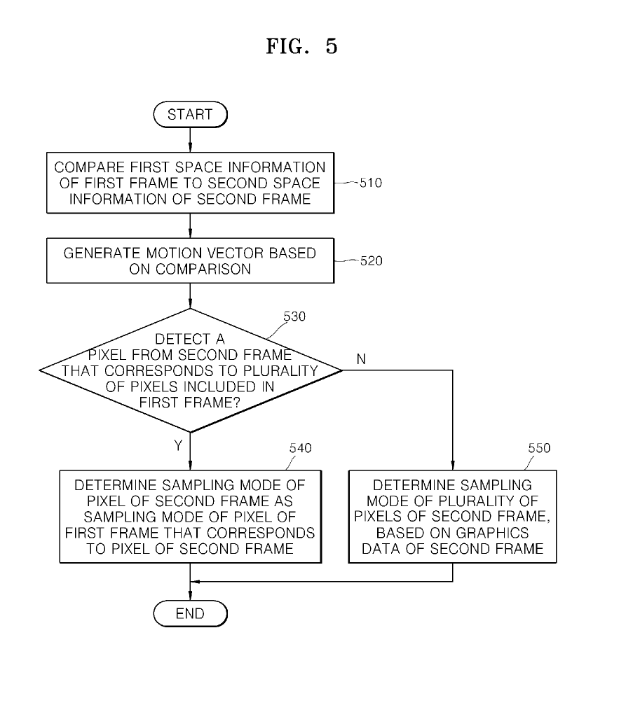

FIG. 5 is a diagram illustrating an example of a method of determining a sampling mode of a plurality of pixels that are included in a second frame based on a motion vector, which is performed by the graphics data rendering apparatus 100.

In operation 510, the graphics data rendering apparatus 100 may compare first space information of a first frame to second space information of the second frame.

In operation 520, the graphics data rendering apparatus 100 may generate a motion vector, based on comparing the first space information to the second space information.

In operation 530, the graphics data rendering apparatus 100 may detect at least one pixel from the second frame, which corresponds to a plurality of pixels included in the first frame, based on the generated motion vector.

In operation 540, the graphics data rendering apparatus 100 may determine a sampling mode of the detected at least one pixel of the second frame, based on a sampling mode of a pixel of the first frame that corresponds to the at least one pixel of the second frame.

In operation 550, the graphics data rendering apparatus 100 may determine a sampling mode of a pixel from among a plurality of pixels that are included in the second frame, not including the detected at least one pixel of the second frame, based on graphics data of the second frame.

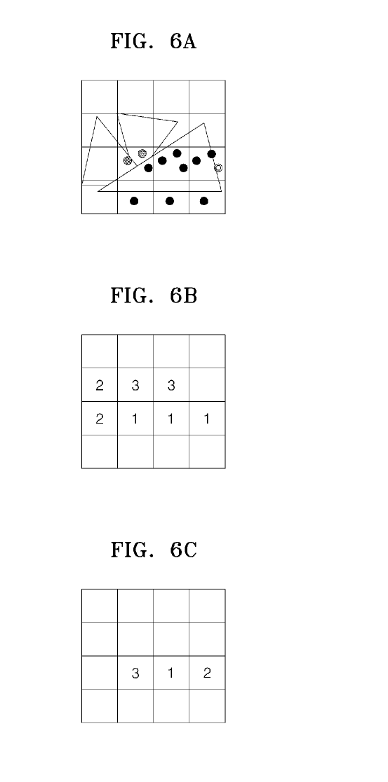

FIGS. 6A through 6C are sequential diagrams illustrating an example of a method of determining a sampling mode of a first frame, which is performed by the graphics data rendering apparatus 100.

FIG. 6A is an example of a diagram illustrating a first frame that includes at least one object. The graphics data rendering apparatus 100 may obtain first space information of at least one object in the first frame. The first space information may include the number of objects that overlap with each other in each of a plurality of pixels that are included in the first frame. The number of objects that overlap with each other may be determined based on a coordinate value of at least one object that is included in a certain pixel.

For example, coordinate values of at least one object which is included in a nth pixel may be (3,4,1), (3,4,0), and (3,4,−1). In this case, since coordinates in a two-dimensional (2D) space are identical to each other, and coordinates that represent depth information in a 3D space are different from each other, the graphics data rendering apparatus 100 may indicate that three objects overlap with each other in the nth pixel.

The graphics data rendering apparatus 100 may determine the number of objects that overlap with each other with regard to each of a plurality of pixels that are included in the first frame, and thus obtain first space information of the first frame.

FIG. 6B is an example of a diagram illustrating a case where first space information is obtained for each of a plurality of pixels based on the number of objects that overlap with each other for each pixel. For example, a pixel which is marked with 2 may indicate that 2 objects overlap each other.

FIG. 6C is an example of a diagram illustrating the number of times a pixel is sampled from a plurality of pixels that are included in the first frame. The number of times a pixel is sampled is determined based on graphics data that is included in the first frame. The graphics data rendering apparatus 100 may determine the number of times for executing effective samplings for each of a plurality of pixels that are included in the first frame, by using a super-sampling method on the first frame. However, this is only a non-exhaustive example, and a sampling mode determined by the graphics data rendering apparatus 100 for each pixel is not limited to a count of effective samplings.

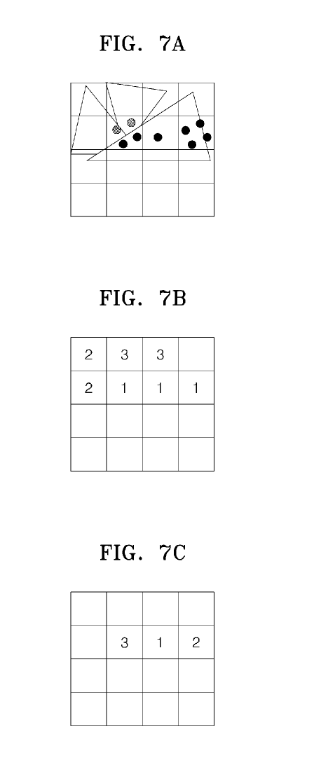

FIGS. 7A through 7C are sequential diagrams illustrating an example of a method of determining a sampling mode of a second frame, which is performed by the graphics data rendering apparatus 100.

FIG. 7A is an example of a diagram illustrating a second frame that includes at least one object. The graphics data rendering apparatus 100 may obtain second space information of at least one object of the second frame. The second space information may include the number of objects that overlap with each other in each of a plurality of pixels that are included in the second frame. The number of objects that overlap with each other may be determined based on a coordinate value of at least one object that is included in a certain pixel.

For example, coordinate values of at least one object which is included in a nth pixel, may be (3,5,1), (3,5,0), and (3,5,−1). In this case, since coordinates in a 2D space are identical to each other, and coordinates that represent depth information in a 3D space are different from each other, the graphics data rendering apparatus 100 may indicate that three objects overlap each other in the nth pixel.

The graphics data rendering apparatus 100 may determine the number of objects that overlap with each other with regard to each of a plurality of pixels that are included in the second frame, and thus obtain second space information of the second frame.

FIG. 7B is an example of a diagram illustrating a case where second space information is obtained for each of a plurality of pixels based on the number of objects that overlap with each other for each pixel.

The graphics data rendering apparatus 100 may generate a motion vector for estimating a motion of at least one object in the first frame, based on the first space information and the second space information. The graphics data rendering apparatus 100 may compare the first space information to the second space information to generate a motion vector between the first frame and the second frame.

For example, the graphics data rendering apparatus 100 may compare first space information, which is obtained with regard to the first frame shown in FIG. 6B, to second space information, which is obtained with regard to the second frame shown in 7B. As a result of the comparison, the graphics data rendering apparatus 100 may obtain information which indicates that graphics data has moved by one pixel in an upward direction in the second frame. A motion vector may be generated based on the information obtained regarding the graphics data.

FIG. 7C is an example of a diagram illustrating information about the number of sampling times that are determined for each of a plurality of pixels included in the second frame, based on a motion vector and a sampling mode of each of the pixels of the first frame. This determination is done by the graphics data rendering apparatus 100.

The graphics data rendering apparatus 100 may detect a pixel that corresponds to a plurality of pixels that are included in the first frame, based on a generated motion vector. The graphics data rendering apparatus 100 may determine that a sampling mode of the detected pixel of the second frame is equal to a sampling mode of a pixel of the first frame, which corresponds to the detected pixel of the second frame.

Referring to FIGS. 6C and 7C, it may be understood that information about the number of times of executing sampling on three pixels, shown in FIG. 6C, is determined as information about the number of times of executing sampling on pixels that are moved by one pixel in an upward direction based on the motion vector.

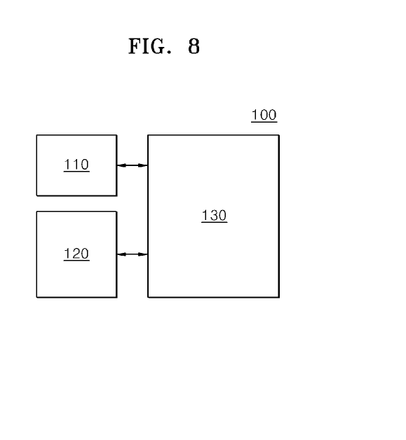

FIG. 8 is a diagram illustrating an example of the graphics data rendering system 100. Referring to FIG. 8, the graphics data rendering system 100 may include a space information obtaining unit 110, a sampling mode determination unit 120, and a rendering unit 130.

The space information obtaining unit 110 may obtain first space information of at least one object, which is represented by graphics data of a first frame.

The sampling mode determination unit 120 may determine a sampling mode of the first frame, based on the graphics data of the first frame.

Based on graphics data that includes color information or depth information of a plurality of pixels that are included in the first frame, the sampling mode determination unit 120 may determine complexity of the plurality of pixels that are included in the first frame.

Based on the graphics data of the first frame, the sampling mode determination unit 120 may determine complexity of the plurality of pixels of the first frame. Additionally, complexity may be determined based on the number of pieces of attribute information of an object, for example, color information or depth information.

Based on complexity determined with regard the plurality of pixels of the first frame, the sampling mode determination unit 120 may determine a sampling mode of the plurality of pixels that are included in the first frame. The sampling mode may include information about the number of times a pixel is sampled, or information about a type of a sampling method.

The sampling mode determination unit 120 may determine a sampling mode based on a sampling level that corresponds to the determined complexity, from among a preset plurality of sampling levels that are classified based on complexity of a predetermined pixel.

The rendering unit 130 may render graphics data of a second frame, based on first space information and the sampling mode of the first frame.

The rendering unit 130 may obtain second space information of at least one object, which is represented by the graphics data of the second frame. The rendering unit 130 may control the space information obtaining unit 110 to generate a motion vector for estimating a motion of at least one object in the first frame, based on the first space information and the second space information. The space information obtaining unit 110 may compare the first space information of the first frame to the second space information of the second frame. The space information obtaining unit 110 may generate a motion vector for estimating a motion of at least one object in the first frame, based on comparing the first space information to the second space information. Space information of at least one object, which is represented by graphics data of a certain frame, may include at least one of location information and depth information of at least one object in the frame.

The rendering unit 130 may control the sampling mode determination unit 120 to determine a sampling mode of the second frame, based on a generated motion vector and the sampling mode of the first frame. Based on the generated motion vector, the sampling mode determination unit 120 may detect a pixel from the second frame, which corresponds to a plurality of pixels of the first frame. The sampling mode determination unit 120 may determine that a sampling mode of the detected pixel of the second frame is equal to a sampling mode of a pixel of the first frame, which corresponds to the detected pixel of the second frame.

The sampling mode determination unit 120 may determine a sampling mode of pixels from among the plurality of pixels of the second frame, other than the detected pixel of the second frame, based on the graphics data of the second frame.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rendering method, comprising:
obtaining, at a graphics data renderer, first space information of at least one object corresponding to graphics data of a first frame;
determining a sampling mode of the first frame, based on the graphics data; and
rendering graphics data of a second frame based on the first space information and the sampling mode of the first frame.

2. The rendering method of claim 1, wherein the rendering of the graphics data comprises rendering the graphics data based on space information of at least one object corresponding to graphics data of a previous frame from among a plurality of frames and a sampling mode of the previous frame.

3. The rendering method of claim 1, wherein the determining of the sampling mode of the first frame comprises:
determining complexity of a plurality of pixels included in the first frame based on graphics data comprising color information or depth information of the plurality of pixels; and
determining a sampling mode of at least one of the plurality of pixels included in the first frame based on the determined complexity of the at least one pixel,
wherein the sampling mode comprises information about a number of times a pixel is sampled and information about a type of a sampling method.

4. The rendering method of claim 3, wherein the determining of the sampling mode comprises determining the sampling mode based on a sampling level that corresponds to the determined complexity, from among a plurality of sampling levels.

5. The rendering method of claim 1, wherein the rendering of the graphics data comprises:
obtaining second space information of at least one object corresponding to graphics data of the second frame;
generating a motion vector to evaluate a motion of at least one object in the first frame based on the first space information and the second space information; and
determining a sampling mode of the second frame based on the generated motion vector and the sampling mode of the first frame.

6. The rendering method of claim 5, wherein the generating of the motion vector comprises:
comparing the first space information of the first frame with the second space information of the second frame; and
generating the motion vector based on the comparing,
wherein space information comprises at least one of location information or depth information of the at least one object in a frame.

7. The rendering method of claim 5, wherein the determining of the sampling mode of the second frame comprises:
detecting a pixel from the second frame that corresponds to a plurality of pixels included in the first frame based on the generated motion vector; and
determining a sampling mode of the detected pixel to be same as a sampling mode of a pixel of the first frame, wherein the pixel of the first frame corresponds to the detected pixel of the second frame.

8. The rendering method of claim 7, wherein the determining of the sampling mode of the second frame comprises determining a sampling mode of pixels from among a plurality of pixels of the second frame, other than the detected pixel of the second frame, based on the graphics data of the second frame.

9. A non-transitory computer-readable storage medium having stored thereon a computer program, which when executed by a computer, performs the method of claim 1.

10. A rendering apparatus, comprising:
a space information obtainer configured to obtain first space information of at least one object corresponding to graphics data of a first frame;
a sampling mode determiner configured to determine a sampling mode of the first frame based on the graphics data; and
a renderer configured to render graphics data of a second frame based on the first space information and the sampling mode of the first frame.

11. The rendering apparatus of claim 10, wherein, the renderer is further configured to renders graphics data of a current frame based on space information of at least one object corresponding to graphics data of a previous frame from among a plurality of frames and a sampling mode of the previous frame.

12. The rendering apparatus of claim 10, wherein the sampling mode determiner is further configured to:
determine complexity of a plurality of pixels included in the first frame based on graphics data comprising color information or depth information of the plurality of pixels; and
determine a sampling mode of at least one of the plurality of pixels included in the first frame based on the determined complexity of the at least one pixel,
wherein the sampling mode comprises information about a number of times a pixel is sampled and information about a type of a sampling method.

13. The rendering apparatus of claim 12, wherein the sampling mode determiner is further configured to determine the sampling mode based on a sampling level that corresponds to the determined complexity, from among a plurality of sampling levels.

14. The rendering apparatus of claim 10, wherein the renderer is further configured to:
control the space information obtainer to obtain second space information of at least one object, which is represented by graphics data of the second frame;
generate a motion vector to evaluate a motion of at least one object in the first frame based on the first space information and the second space information, and
determine a sampling mode of the second frame based on the generated motion vector and the sampling mode of the first frame.

15. The rendering apparatus of claim 14, wherein the space information obtainer is further configured to:
compare the first space information of the first frame with the second space information of the second frame; and
generate the motion vector based on the comparison, and
wherein space information comprises at least one of location information or depth information of the at least one object in a frame.

16. The rendering apparatus of claim 14, wherein the sampling mode determiner is further configured to:
detect a pixel from the second frame that corresponds to a plurality of pixels included in the first frame based on the generated motion vector, and
determine a sampling mode of the detected pixel to be same as a sampling mode of a pixel of the first frame, wherein the pixel of the first frame corresponds to the detected pixel of the second frame.

17. The rendering apparatus of claim 16, wherein the sampling mode determination unit determines a sampling mode of pixels from among a plurality of pixels that are included in the second frame, other than the detected pixel of the second frame, based on the graphics data of the second frame.
